(19) United States
(12) Patent Application Publication
(10) Pub. No.: US 2010/0028218 A1
(43) Pub. Date: Feb. 4, 2010

(54) PROCESS AND DEVICE FOR COOLING INORGANIC PIGMENT

(75) Inventors: ROBERT J. SARRACINI, EATON (AU); JOHN Y. WONG, AUSTRALIND (AU); SHANE R. GARTON, BUNBURY (AU)

Correspondence Address: DUNLAP CODDING, P.C., PO BOX 16370, OKLAHOMA CITY, OK, 73113, US

(73) Assignee: MILLENIUM INORGANIC CHEMICALS, INC., HOUSTON, TX (US)

(21) Appl. No.: 12/551,133

(22) Filed: Aug. 31, 2009

Related U.S. Application Data
(62) Division of application No. 11/290,012, filed on Nov. 30, 2005.
(60) Provisional application No. 60/632,246, filed on Nov. 30, 2004.

(51) Int. Cl. C09C 1/00

(52) U.S. Cl. 422/150

(57) ABSTRACT

A system for manufacturing a pigment comprising an oxidation reactor capable of providing a pigment, a scouring media source, and a heat exchanger having a tubular conduit through which the mixture of the pigment and the scouring media flows. The tubular conduit having an inlet, an outlet, and a longitudinal center line. The tubular conduit configured such that at least a portion of the longitudinal center line of the tubular conduit extends in a helical pattern.

### CROSS-REFERENCE TO RELATED APPLICATIONS

This application is a divisional of U.S. patent application Ser. No. 11/290,012, filed Nov. 30, 2005, which claims the benefit of U.S. Provisional Application No. 60/632,246, filed Nov. 30, 2004, each being expressly incorporated herein by reference in their entirety.

### BACKGROUND OF THE INVENTION

The present invention relates to a system for manufacturing inorganic pigments, and more particularly, but not by way of limitation, to a system for manufacturing titanium dioxide wherein the system includes a heat exchanger having a tubular conduit with at least one helical portion.

One well known method of making titanium dioxide is the chloride process. According to this method, titanium tetrachloride and oxygen, in gaseous form, are mixed in a reactor at high flow rates. The reactor is operated at a high temperature, which facilitates the formation of particulate titanium dioxide and gases. These products are subsequently cooled as they pass through a conduit that is typically a tubular heat exchanger which may, for example, be immersed in a flue pond to facilitate heat exchange.

In order to improve the efficiency of chloride processes, a scouring medium can be added to the heat exchanger to remove products that adhere to the inside surfaces of the conduit. A variety of scouring media are known in the art.

Typically, scouring media only partially remove deposits from the inside surfaces of the conduit. To the extent that deposits on the conduit surface are not removed, these deposits interfere with heat exchange. For example, as deposits adhere to the inner surface of the conduit, heat exchange in the conduit becomes less and less efficient, which adversely affects the ability of the titanium dioxide to cool in a satisfactory manner. This in turn leads to a possible decline in quality of the titanium dioxide particles.

In order to improve the quality of TiO₂ particles produced by the chloride process and the efficiency of the processes themselves, tubular heat exchangers that are straight but comprise abrupt bends, or doglegs, may be included. Although such heat exchangers can be more effective heat exchangers than those lacking such abrupt bends, they can be somewhat disadvantageous due to rapid wear from the large angle of the bend. This wear can result in high maintenance costs. Tubular heat exchangers that are straight but comprise sweeping bends, e.g., wide angled bends, are also known in the art. These may present less wear than tubular heat exchangers with abrupt bends.

Parameters other than the shape of the pipe may also be modified to improve efficiency of heat exchange. For example, tubular heat exchangers for the cooling of titanium dioxide pigments, with internal fins, are known in the art. Internal fins are employed in an effort to enhance cooling by the tubular heat exchanger. Also known in the art are flues that have a plurality of internal longitudinal protuberances, depressions, or both. Furthermore, the interior surface of the flue can be corrugated and can have a plurality of protuberances that are fins, which, for example, can be hollow. Additionally, tubular heat exchangers for the cooling of titanium dioxide pigments, with internal spiraling vanes, are known in the art.

Unfortunately, tubular heat exchangers that merely have protuberances, depressions, spiraling vanes, or recesses disposed on their internal surfaces, have certain disadvantages. The features on the internal surfaces can serve to promote build-up of deposits at the location of these features, and can interfere with effective scouring of the internal surface of the heat exchanger. These disadvantages can reduce heat transfer efficiency. These features may also add significant costs to the construction of a heat exchanger.

As stated above, heat transfer efficiency in the tubular heat exchanger may be improved by having the scouring medium follow a spiral path by the use of, for example, four spiraling vanes and recesses on the inside surface of the tubular heat exchanger. Unfortunately, excessive use of scouring media can adversely affect the quality of inorganic pigment particles.

Thus, a need remains to develop a system for manufacturing inorganic pigments, for example, titanium dioxide, by utilizing a heat exchanger having a tubular conduit with at least one helical portion where build-up of deposits is avoided, interference with effective scouring of the internal surface of the heat exchanger is reduced, and the use of scouring media is reduced. The present invention provides a solution.

### BRIEF DESCRIPTION OF THE FIGURES

FIG. 1 is a schematic representation of a system for manufacturing a pigment.

FIG. 2 is a top plan view of a heat exchanger for use in the system of FIG. 1.

FIG. 3A is a perspective view of a helical portion of a tubular conduit for use in the system of FIG. 1.

FIG. 3B is a perspective view of the helical portion of the tubular conduit showing a longitudinal axis of the tubular conduit.

FIG. 3C is a diagrammatic representation of a portion of the tubular conduit shown in FIG. 2.

FIG. 3D is a perspective view of the helical portion of the tubular conduit showing the helix angle of the helical portion.

### DETAILED DESCRIPTION OF THE PREFERRED EMBODIMENTS

The present invention will now be described in connection with preferred embodiments. These embodiments are presented to aid in an understanding of the present invention and are not intended to, and should not be construed, to limit the invention in any way. All alternatives, modifications and equivalents that may become obvious to those of ordinary skill upon reading the disclosure are included within the sprit and scope of the present invention. For a better understanding of the present invention together with other and further advantages and embodiments, reference is made to the following description taken in conjunction with the examples, the scope of the invention which is set forth in the appended claims.

This disclosure is not a primer on processes for making inorganic pigments; basic concepts known to those skilled in the art have not been set forth in detail.

### Definitions

Unless otherwise specified, or apparent from context, the phrases and terms used herein include the following meanings.

Abrupt Bend—The phrase “abrupt bend,” as used herein, includes what are referred to in the art as “dog legs.” An “abrupt bend” or “dog leg” is a bend in a conduit or flue that represents a deviation in a straight or linear conduit or flue. An “abrupt bend” is typically a turn of angle from about 90 to about 170 degrees. An “abrupt bend” is distinguished from a “sweeping bend” in that in an abrupt bend there is a sudden transition or change of angle, which alters sharply the direction of flow as opposed to a gradual, smooth, and uniform transition of flow for a sweeping bend.

Conduit—The term “conduit”, as used herein, includes a pipe or flue, or any other structure that can enclose gaseous, vaporous and particulate reactants and reactant products and provide a pathway for them to travel away from the zone in which they are formed. The term “conduit” includes, but is not limited to, tubular heat exchangers. The conduit can be made from any material known in the art, or that a person of ordinary skill in the art with this disclosure in hand, would appreciate would be useful in the practice of this invention.

Cooling—The term “cooling”, as used herein, includes a reduction in temperature of matter. Using the methods and articles of manufacture described in this disclosure in accordance with the invention, matter traveling through the conduit of the invention will experience reduction in temperature.

Constant Helix Angle—The phrase “constant helix angle,” as used herein, includes a helix angle that does not vary from one helix, helical segment, or helical bend, when compared to other helices, helical segments, or helical bends according to the present invention. The phrase “helical segment” is meant to include a segment of a conduit that comprises a helix. Typically, but not necessarily, a “helical segment” is a segment of pipe that comprises a full helical turn (i.e., 360 turn of a helix), wherein the segment of pipe can be, for example, welded, or otherwise attached, to one or more other pipe segments. The one or more other pipe segments comprise one or more helical segments, one or more bends, and/or one or more straight runs.

Depression—The term “depression,” as used herein, includes a deviation on the inside surface of a tubular heat exchanger that describes an involution of the inside surface of the tubular heat exchanger.

Fin—The term “fin,” as used herein, includes a protuberance on the inside surface of a tubular heat exchanger. The “fin” may be comprised of the same or different composition as the tubular heat exchanger. The “fin” may be triangular or may take any shape that aids in heat exchange, reduction in build-up, and/or efficiency of scouring.

Helical Bend—The phrase “helical bend,” as used herein, includes a portion of a helix. The phrase “portion of a helix” is any length of helix that ramifies about an imaginary central axis in accordance with the formula of a helix. Many formulas describing helices are known in the art.

Helix—The term “helix,” as used herein, includes a circular helix, which can typically be described by a well known vector function, for example, the vector function r(t)=a cos ti+a sin tj+c+k, wherein c does not equal zero. Typically, but not always, a helix will lie within an imaginary circular cylinder described by x²+y²=a². Where c>0, the helix is a right-handed circular helix. There c<0, the helix is a left-handed circular helix. As used herein, unless otherwise specified or indicated by the context, however, “helix” is meant to be construed in its broadest sense. The helices of the present invention can be described by any formulas known in the art and are thus not limited to regular helices nor regular helices that can be contained within regular cylinders. In one non-limiting example, “helix” can include a helix that is not uniformly straight, e.g., the helix need not lie in a straight cylinder, but the cylinder within which the helix can be thought to be contained can, itself, comprise one or more curves. In another non-limiting example, helices of the invention do not necessarily need to be uniform and regular, e.g., deviation from the central axis of the helix need not be uniform.

Helix Angle α—The phase “helix angle,” as used herein, includes the angle formed by the direction of travel of the helical conduit, which determines its helical periodicity and magnitude around an imaginary straight central axis drawn through the center of a straight tubular conduit or imaginary cylinder. The “helix angle” is measured in three dimensional coordinates with the x-axis pointing in the direction of the central axis and tangent to any point on a line traced out by the locus of travel of the helical conduit.

The helix angle values used in this disclosure are a corollary analogy. The values are expressed in this disclosure in a manner that may be the inverse of the usual, or common, definition employed by many persons who are skilled in the art of mechanical engineering. For example, to many persons skilled in the art of mechanical engineering, the helix angle may be defined by the nominal length of a helix against the circumference of the imaginary cylinder that the center of the helical pipe is coiled onto. Thus, with respect to usage herein, three degrees as used herein may be to a person skilled in the art of mechanical engineering more typically referred to as 87 degrees, five degrees as referred to herein may be more typically referred to as 85 degrees, and so on. The expression of helix angle values in this disclosure are, for purposes of convenience only, five degrees rather than 85 degrees, and three degrees rather than 87 degrees, and so on.

Inorganic Pigment—The term “inorganic pigment,” as used herein, includes any inorganic pigment known in the art, or that comes to be known and/or can be cooled using a conduit or one of the methods of the present invention. Preferably, the inorganic pigment is a titanium-based pigment. More preferably, the inorganic pigment is an oxide of titanium. Most preferably, the inorganic pigment is titanium dioxide.

Rifle—The term “rifle,” as used herein, includes a depression of the internal surface of a tubular heat exchanger, wherein the depression occurs over at least one spiral turn or full turn of a helix.

Scouring Medium—The phrase “scouring medium,” as used herein, includes any medium known in the art, or that comes to be known in the art, that is useful for scouring in a tubular heat exchanger. “Scouring media” include, but are not limited to, sand, mixtures of inorganic pigment such as, for example, titanium dioxide and/or sintered titanium dioxide in any acceptable form to achieve scouring, compressed pigments such as compressed titanium dioxide, salts and salt mixtures, rock salts, alumina, and fused alumina. Salts can include, for example, potassium chloride, sodium chloride, and cesium chloride.

Spiral Turn—The phrase “spiral turn,” as used herein, includes a portion of a helix that describes a full turn of the helix.

Sweeping Bend—The phrase “sweeping bend,” as used herein, includes bends that allow for a heat exchanger to be contained in a flue pond. Typically, the length of a heat exchanger can be increased by introducing one or more “sweeping bends” into the heat exchanger, allowing it, for example, to follow the contours of a flue pond. “Sweeping bends” preferably have wide angles which are defined by their radii of curvature.

Vane—The term “vane,” as used herein, includes a protuberance on the inside surface of a tubular heat exchanger. The “vane” may be of the same or different composition as the tubular heat exchanger. The “vane” may be triangular, or may take any shape that aids in heat exchange, reduction in build-up, and/or efficiency of scouring.

Variable Helix Angle—The phase “variable helix angle,” as used herein, includes a helix angle that can vary along a helix or helical portion.

### Preferred Embodiments

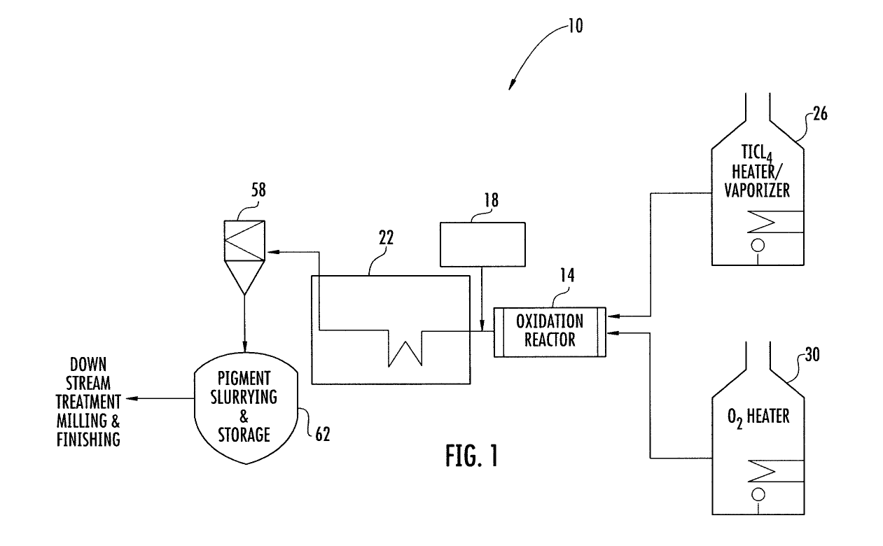

Referring now to the drawings, and more particularly to FIG. 1, shown therein is a system 10 for manufacturing an inorganic pigment. In one embodiment, the system 10 includes at least an oxidation reactor 14 capable of providing a pigment, a scouring media source 18 capable of providing a scouring media, and a heat exchanger 22. The inorganic pigment utilized in the system 10 comprises titanium, and in one embodiment, the inorganic pigment may comprise one or more titanium oxides. In another embodiment, the inorganic pigment may be titanium dioxide. Titanium dioxide can be made by the system 10 with any method known in the art such as, for example, the sulfate process or the chloride process. In accordance with the present invention, titanium dioxide is made using the chloride process. In the chloride process, titanium tetrachloride is reacted with oxygen in the oxidation reactor 14 which operates at a high temperature (at or above 650° C.). After the titanium tetrachloride is reacted with oxygen in an oxidation reaction to produce titanium dioxide, the titanium dioxide is rapidly cooled in a length of pipe, sometimes referred to as the heat exchanger 22 and/or flue pipe, as will be discussed in greater detail below.

The oxidation reactor 14 may include any suitable apparatus and/or combination of apparatuses and/or devices which can provide a pigment, for example, an inorganic pigment. The oxidation reactor 14 receives titanium tetrachloride from a heater/vaporizer 26 and oxygen from an oxygen heating source 30. The titanium tetrachloride and oxygen are mixed together in the oxidation reactor 14 to produce the inorganic pigment, which in this case includes titanium dioxide. The titanium dioxide exiting the oxidation reactor 14 is then combined with a scouring media to ensure good heat transfer as the mixture is communicated through the heat exchanger 22. The scouring media is typically added to the hot gaseous stream of titanium dioxide to remove excess buildup of inorganic pigment on the inner surface of the heat exchanger 22, as will be discussed in greater detail below.

Any scouring media, or combination of scouring media, now known in the art or that comes to be known, can be used in conjunction with the present invention. Common scouring media include any abrasive substance including, for example, sand, rock salt, sodium chloride, potassium chloride, cesium chloride, pelleted or sintered titanium dioxide, compacted particles of titanium dioxide, and the like. It is known in the art that a bimodal particle size distribution of scouring agent is particularly effective, and the use of salt has benefits including a reduction in pressure drop over the bag filter used to separate the titania particles from the chlorine, as will be discussed in greater detail below.

Additionally, the scouring media can comprise, for example, sand, one or more metal halides, CsCl, compacted TiO₂ particles, calcined TiO₂ particles, or combinations thereof. Where the scouring media includes one or more metal halides, the metal halide is preferably NaCl, KCl, or a combination thereof.

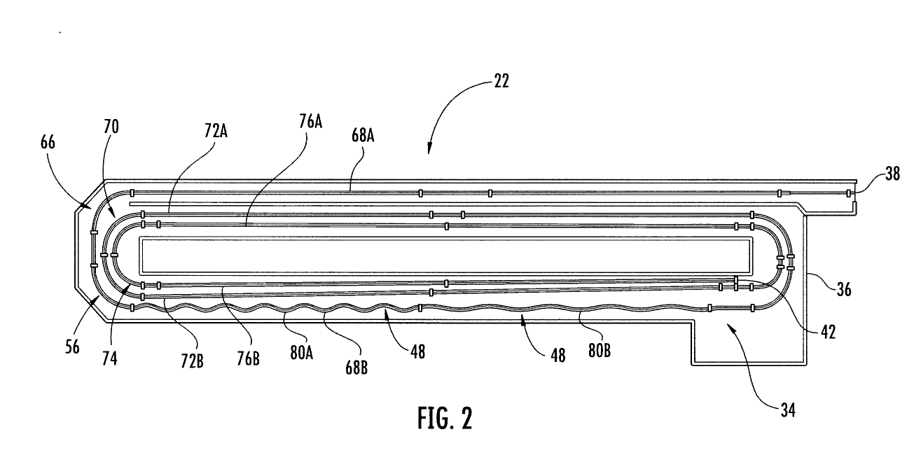

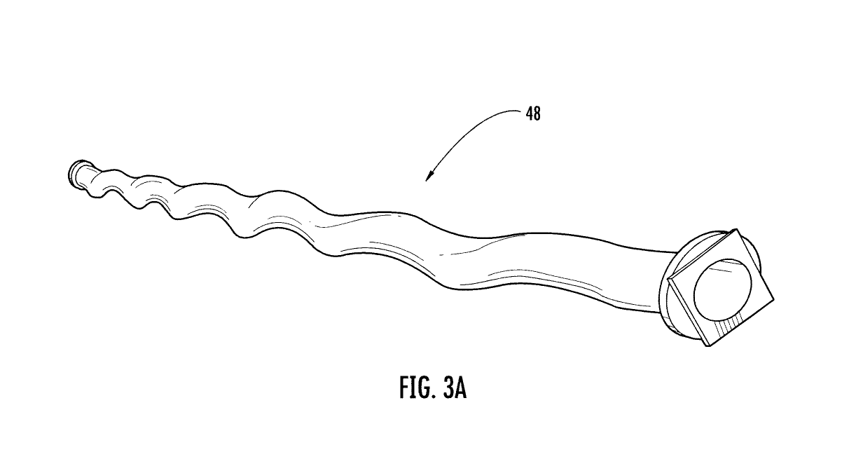

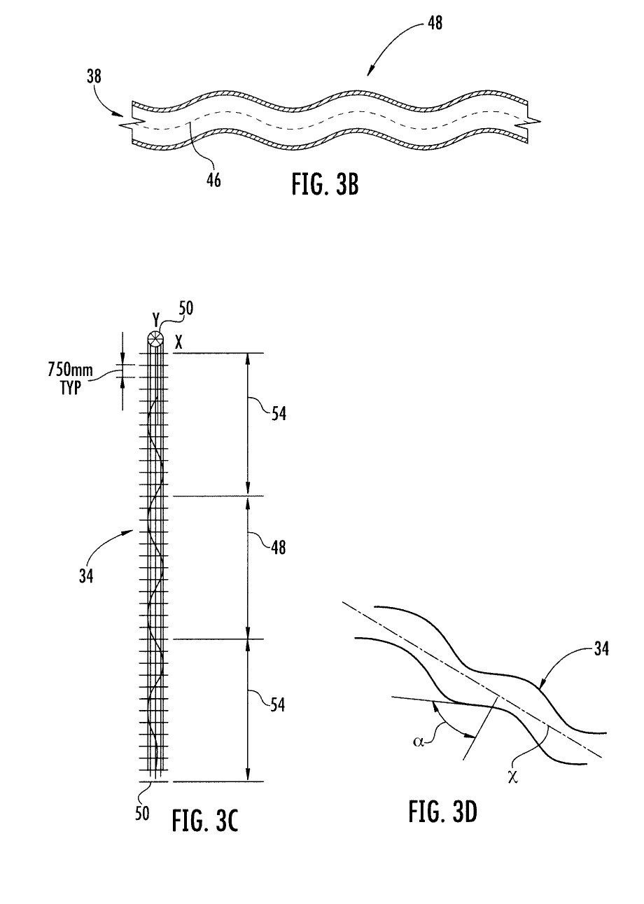

Referring now to FIGS. 2-3D collectively, the mixture of titanium dioxide and scouring media, hereinafter referred to as the “mixture” is cooled in the heat exchanger 22. The heat exchanger 22 includes a tubular conduit 34 through which the mixture flows and a cooling source, such as a flue pond 36. In one embodiment, the tubular conduit 34 has an inlet 38, an outlet 42, and a longitudinal center line 46. The inside surface (not shown) of the tubular conduit 34 may include one or more fins, vanes, rifles, depressions, spirals, or combinations thereof. The one or more fins, vanes, rifles, depressions, spirals, or combinations thereof can be utilized in any segment of the tubular conduit 34.

The tubular conduit 34 may be fabricated from a strong and resilient material which can withstand temperatures of 650° C. or greater such as metal, or a metallic alloy, although other suitable materials which would be known to one of ordinary skill in the art with the present disclosure before them are likewise contemplated for use in accordance with the present invention.

The tubular conduit 34 is configured in such a way that at least a portion of the longitudinal center line 46 of the tubular conduit 34 extends in a helical pattern. The portion of the tubular conduit 34 that extends in a helical pattern will be hereinafter referred to as “helical portion” 48.

The tubular conduit 34 may have at least one helical portion 48 extending from at least one non-helical portion or between two non-helical portions. Additionally, the tubular conduit 34 may be fabricated such that a substantial majority of the longitudinal center line 46 of the tubular conduit 34 extends in a helical pattern. In one embodiment, the tubular conduit 34 may include terminal ends 50 having transition segments 54. In the transition segments 54, the helix angle α of the tubular conduit 34 transitions to zero such that the ends of the tubular conduit 34 are substantially linear.

In one embodiment, the helical portion 48 of the tubular conduit 34 preferably has a helix angle α from one degree to twenty-five degrees. In another embodiment, the helix angle α is from two to ten degrees. In yet another embodiment, the helix angle α is from three to five degrees. In an additional embodiment, the helix angle α is five degrees. The helix angle α can be constant along the helical portion 48, or alternatively, the helix angle α can vary along the length of the helical portion 48. Considerations in selecting a suitable helix angle α include the efficacy of the resulting tubular conduit 34 in achieving improved heat transfer as compared to a tubular conduit 34 without helical portions 48, the efficacy of scouring, the build-up of deposits on the inner surface of the tubular conduit 34, and the wear of the internal surfaces of the tubular conduit 34. Efficiency of a tubular conduit 34 having helical portions 48 can be improved by increasing the helix angle α to, for example, five degrees, allowing shortening of the tubular conduit 34 and permitting more helical portions 48 per unit length of the tubular conduit 34 as compared to helix angles α of less than five degrees.

In one embodiment, at least 10% of the tubular conduit 34 is comprised of a helical portion 48. In another embodiment, at least 50% of the tubular conduit 34 is comprised of a helical portion 48 and in yet another embodiment, 75% to 100% of the tubular conduit 34 is comprised of a helical portion 48.

The tubular conduit 34 may comprise a helical portion 48 with at least one 360 degree spiral turn. In one embodiment, the tubular conduit 34 may comprise a helical portion with at least two 360 degree spiral turns. In another embodiment, the tubular conduit 34 comprises a helical portion 48 with at least three 360 degree spiral turns. In general, the longer the tubular conduit 34, the more 360 degree spiral turns the tubular conduit 34 may comprise.

The tubular conduit 34 can also comprise one or more abrupt bends (not shown) also known as “dog legs.” It will be understood that abrupt bends should be kept to a minimum as abrupt bends may lead to significant maintenance cost from high wear. Alternatively, in addition to the helical portions 48, the tubular conduit 34 may comprise at least one sweeping bend 56 (see FIG. 2). The sweeping bend 56 is typically a wide angle bend in the tubular conduit 24 of the heat exchanger 14. Sweeping bends 56 may be desirable where a greater length of tubular conduit 34 is desired in a single flue pond 36. For example, a rectangular flue pond 36 can be made to contain more tubular conduit 34 length where sweeping bends 56 are used so that the tubular conduit 34 can turn within the flue pond 36 to, for example, follow the perimeter of the flue pond 36.

A suitable tubular conduit 34 can be designed by selecting a tubular conduit 34 comprising at least one helical portion 48 of constant or variable helix angle α, and disposing at least a portion of the tubular conduit 34 in the flue pond 36. In one embodiment, the flue pond 36 may include, for example, a concrete enclosure filled with a cooling liquid such as water. The tubular conduit 34 is disposed at least partially within the flue pond 36 and contacts the cooling liquid in order to facilitate heat transfer between the tubular conduit 34 and the cooling liquid. Temperature surveys of the flue pond 36 in the vicinity of the tubular conduit 34 at various points along the tubular conduit 34 can be taken to measure the heat balance around the flue pond 36 and determine heat transfer dynamics of the tubular conduit 34. These temperature surveys can be used to estimate heat fluxes of various sections of the tubular conduit 34 and the temperatures of the flow stream inside the tubular conduit 34.

To construct the tubular conduit 34, individual sections of conduit are connected, such as, for example, by bolting the individual sections together. It will be understood that many methods of making conduit are known in the art and any suitable method may be employed. For example, producing tubular conduit 34 having helical portions 48, straight conduit is cut into desired lengths, usually with each length long enough for making one helical portion 48. Each length of conduit is then individually heated inductively and twisted such that the length has the proper helix angle α. The fabricated lengths are welded together afterwards to form the tubular conduit 34.

In an additional embodiment, the tubular conduit 34 may comprise one or more lumen that contains titanium dioxide in addition to, or potentially in lieu of, the titanium dioxide received from the oxidation reactor 14.

After cooling the inorganic pigment in the heat exchanger 22, the inorganic pigment is communicated through a filter 58 where excess scouring media is removed from the inorganic pigment. Next, the filtered inorganic pigment is communicated to a slurrying and/or storage apparatus 62 designed to receive, store and/or discharge the inorganic pigment.

### Examples

Referring now to FIGS. 2 and 4 collectively, the following non-limiting examples 1-6 include exemplary tests and data indicative of the effects of various bends, helical portions and locations thereof on the performance of the tubular conduit 34 with regards to heat transfer, scouring media usage, and the like within the flue pond 36 of the heat exchanger 22. The tubular conduit 34 is shown as having a first loop 66 with first and second straights 68A and 68B, a second loop 70 with third and fourth straights 72A and 72B, and third loop 74 with fifth and sixth straights 76A and 76B. The loops 66, 70, and 74 extend in a spiral pattern around the flue pond 36. Helical portions 48 were installed along the straights of the loops at various locations and tests were performed to measure the efficacy of the helical portions 48 in relation to straight portions in the same location.

### Example 1

### Helical Portion having a Helical Portion with a Three Degree Helix Angle

A helical portion 48 made from a 27.5 meter-long pipe with a 300 mm diameter, having a constant helix angle α of three degrees were installed in a flue pond. The tubular conduit 34 having the helical portion 48 was connected directly to the outlet of an oxidation reactor. The tubular conduit 34 was immersed in cooled water with a helical portion 48 installed along the second straight 68B of the first loop 66. The helical portion 48 removed an additional 83 kJ/s of heat as compared with a straight conduit of the same nominal length in the same position, rendering the helical portion 48 approximately 21.6% more efficient than the straight conduit. If the helical portions 48 were uncoiled, the tubular conduit 34 would be longer by about 0.25 meters per helical portion 48. The furthest deviation of the helical portion was 100 mm from the center of the axis X of the tubular conduit 34 and the maximum crest-to-crest deviation was 200 mm. The 100 mm maximal deviation was selected so that no portion of the tubular conduit 34 was elevated above or below a flange or edge of the flue pond 36, and that the tubular conduit 34 would not contact the flue pond wall or the loops of the tubular conduit 34 would not contact one another. The helical portion 48 was constructed of Inconel 600 alloy pipe, schedule 40 or 90 to 11 mm wall thickness. This material is particularly suited to high temperature and hot chlorine duty. Other higher grades of the same alloy such as Inconel 601 and 625 are also suitable. Hastelloys can be used as well, however, they are all more costly than Inconel 600 and only marginally superior.

Temperature surveys of the flue pond 36 were carried out to establish the heat balance around the flue pond 36 and establish the heat transfer dynamics of the tubular conduit 34. The results were also used to estimate the heat fluxes of various sections of the tubular conduit 36 and the temperatures of the flow stream inside the tubular conduit 36.

The predominant amount of heat associated with making titanium dioxide, about 60% of the total, was generated by the TiCl₄ to TiO₂ reaction. The majority of the heat—about 73% to 76%—was removed by the first straight 68A up to the second sweeping bend 56. Regarding the titanium dioxide grade made, i.e., neutral tone grade versus blue tone grade, the remainder of the tubular conduit 34 after the second sweeping bend 56 removed more heat by 200 to 300 kJ/s. This could be related to either lower velocity of the flow stream or longer residence time of the neutral tone run. This may have accounted for the lower scrub salt usage of 0.3 to 0.5% for neutral tone production in comparison to blue tone. The scrub salt only affected the first straight 68A of the tubular conduit 34. This was evident in three trials in which the bag filter inlet temperature was reduced by 15 degrees C. from 195 degrees C. to 180 degrees C. Both the second bend and third bend temperatures dropped by the same margin. The theoretical calculated temperature of the reaction products was estimated to be about 2,100 degrees C. The actual temperature was probably several hundred degrees lower due to the highly endothermic dissociation of a percentage of the Cl₂. Depending on the flue pond water final temperature, the evaporative heat loss varied from 3000 to 5000 kJ/s or 30% to 45% of the total heat rejected from the tubular conduit 34 into the flue pond 36 water. The amount of water lost through evaporation to the atmosphere was significant at 5 to 7.5 m³/h. The heat flux of the tubular conduit 34 varied from 138 kJ/m² to 5.6 kJ/m². The high number was from the 225 mm NB (nominal bore or nominal internal diameter) tubular conduit 34 on the first straight 66A and the latter near to the end of the tubular conduit 34.

### Example 2

### Scrub Salt Usage

Average data for scrub salt usage during runs with and without a helical portion 48 are displayed in Table II:

TABLE II
Average Scrub Salt Usage

| Run | Rate (tph) | NaCl (%) | Grade | Helical or Straight |
|---|---|---|---|---|
| 1 | 11.4 | 2.29 | Neutral tone | Straight portion |
| 2 | 10.47 | 3.48 | Blue tone | Helical portion |
| 3 | 11.30 | 2.32 | Neutral tone | Helical portion |
| 4 | 11.00 | 2.13 | Neutral tone | Helical portion |
| 5 | 10.40 | 2.59 | Blue tone | Helical portion |
| 6 | 11.33 | 1.91 | Neutral tone | Helical portion |
| 7 | 9.24 | 1.29 | Neutral tone | Helical portion |
| 8 | 9.39 | 1.93 | Blue tone | Helical portion |
| 9 | 10.24 | 1.73 | Neutral tone | Helical portion |
| 10 | 10.27 | 2.31 | Blue tone | Helical portion |
| 11 | 9.88 | 2.57 | Blue tone | Straight portion |
| 12 | 11.27 | 2.22 | Neutral tone | Straight portion |

Run number describes runs for this specific study described in this table.

Scrub salt usage was about 0.3 to 0.5% lower for the neutral tone run. Variation of NaCl scrub salt and rate on a daily basis was measured for nine months with the helical portion 48 in place, and averaged about 15% less than when using a tubular conduit 34 having no helical portions 48 when normalized to reactor rate.

The 0.3 to 0.5% scrub salt difference between blue tone and neutral tone corresponded to the 200 to 300 kJ/s heat removal after the third bend. The helical portion 48 removed additional 83 kJ/s of heat in a blue tone run, relative to a straight tubular portion. This would be at least equivalent to=83/200×0.3=0.125% or about 0.1% scrub salt reduction.

### Example 3

### Scouring, Wear, and Flow Resistance Using Helical Portion

The helical portion 48 was removed between runs 3 and 4 in Table II, and a video was taken on the interior surface of the helical portion 48. The video traversed the whole length of the helical portion 48. It showed that the scrub salt scoured mainly the bottom quarter to fifth of the inner surface forming a faintly distinct path. The path of the scouring did follow the helical profile and became slightly more prominent at the most outward points/bends. This indicated the helical portion 48 should have more area for heat transfer and so should be more efficient to remove heat from the flow stream.

Thickness measurements were made on several selected locations (perceived to have high wear) when the helical portion 48 was first taken out. No decrease in thickness or wear occurred. The same measurement was taken when the helical portion 48 was removed from the flue pond 36 following ten months of continuous service and it was discovered that the wear was negligible.

From the tubular conduit differential pressure (that is, the pressure drop across the length of the tubular conduit 34, or DP trend), it was not possible to ascertain if the helical portion 48 contributed to DP increase. If it did, it could have been insignificant, because no drastic increase in flue pipe DP was observed with the 3 degree helical portion 48 in place.

### Example 4

### Helical Portion Efficiency

Helical portion efficiency was determined for a blue tone run conducted. The helical portion 48 removed an additional 83.2 kJ/s of heat relative to the straight conduit it replaced. This was equivalent to an additional heat of 121.6% of the straight conduit or 21.6% more efficient in heat removal. Details of the efficiency calculation are listed below.

With Helical Portion 48 (27 m of helical portion to 32 m of straight pipe, or 46% to 54%)

| | |
|---|---|
| Average second bend temperature: | 669.6° C. |
| Average third bend temperature: | 499.7° C. |
| Average temperature difference: | 169.9° C. |
| Average mass flow: | 35,600 kg/h = 9.89 kg/s |
| Average reaction product heat capacity: | 0.62 kJ/kg/° C. |
| Heat removed: | 1041.7 kJ/s |
| Assume mass flow = 8.89 kg/s | |
| (normalized to be the same as with | |
| straight pipe) | |
| Heat removed: | 936.3 kJ/s |

Without Helical Pipe—With 27.5 m Straight Pipe

| | |
|---|---|
| Average second bend temperature: | 655.3° C. |
| Average third bend temperature: | 500.5° C. |
| Average temperature difference: | 154.8° C. |
| Average mass flow: | 32,000 kg/h = 8.89 kg/s |
| Heat removed: | 853.1 kJ/s |
| Difference in heat removal: | 83.2 kJ/s |

From these data, it was estimated that the helical portion efficiency=(384.5+83.2)/384.5=121.6% of the straight conduit, representing 21.6% greater efficiency in heat removal.

### Example 5

### Helical Portion Having a 5 Degree Helix Angle

A 27.5 meter helical portion 48 with a 5 degree helix angle, having 5½ turns, was made. The helix was left-handed. The helical portion 48 was installed in the second straight 68B of the first loop 66 of tubular conduit 34. The helical pipe 48 has a twist such that the off-center distance increased by only 50 mm more than the helical pipe of Example 1, to ensure that the crests would remain submerged in the flue pond 36. The helical portion 80A with five degree helix angle was placed in tandem with the helical portion 80B having the three degree helix angle. The helical portion 80A with the five degree helix angle was installed along a first length of the second straight 68B flue pipe, and the helical portion 80B with the three degree helix angle was moved to a second length and joined to the helical portion 48 with the five degree helix angle. The five degree helical portion 80A generated more turbulence of the flow stream, which enhanced heat removal. By immediately attaching the three degree helical portion 80B, the more vigorous residual turbulence from the five degree helical portion 80A would continue forward for a longer duration.

### Example 6

### Results of Runs with Tandem Helical Pipes

Runs with the tandem helical portions 80A and 80B reduced scrub salt usage. The average salt content in a slurry containing a pigment collected from the filter and mixed with water before the addition of the helical portion 80A having the five degree helix angle was 2.09% and with the helical pipe 80A having the five degree helix angle was 1.23%. This is equivalent to a reduction of 41.1% in scrub salt usage. Conservatively, if a 30% reduction in scrub salt is assumed, the scrub salt saving would be significant per year. Almost one percent less scrub salt was used with the helical portion 80A of five degree helix angle in tandem with the helical portion 80B of three degree helix angle α, as compared with the helical portion 80B of three degree helix angle, as compared with the helical portion 80B of three degree angle α alone.

Slurry viscosity also decreased across a range of reactor rates using the two helical portions 80A and 80B in tandem. At flow rates from nine to over thirteen tonne per hour, the two helical portions 80A and 80B in tandem (“new five degree helical portion”) consistently produced slurry of about two hundred centipoises (cP) lower than without the two helical portions 80A and 80B (“before new five degree helical portion”). The average reduction in slurry viscosity was from 913 to 553 cP. This was not due to a change in slurry density. Instead, the reduction was due to the reduction in scrub salt, since the slurry solids content actually increased slightly by 26 g/L for the tandem helical portion 80A and 80B runs. Slurry viscosity is affected very much by the pigment slurry solids content as well as scrub salt level. If the slurry is higher in solids or salt content or both, the slurry viscosity is higher. In this case, the solids content of the slurry had increased slightly, but the reduction in salt level still resulted in a significant fall in slurry viscosity.

The tandem helical portions 80A and 80B affected tubular conduit 34 pressure drop in a consistent manner, linear with plant rates. However, the tandem helical portion 80A and 80B arrangement generated higher pressure drop—approximately 25 kPa higher.

Some reduction in sand mill feed slurry viscosity was observed. The average was 265 cP, before the helical portion 80A having a five degree helix angle was added, and 163 cP after the helical portion 80A having five degree helix angle was added. Reduction in sand mill feed slurry viscosity would permit more efficient milling and could also allow slight increases in milling rate.

Reduced scrub salt and less heat transfer at the first straight of the tubular conduit 34 since addition of the helical pipe 80A with five degree angle can lead to changes in pigment particle size. Immediate quenching of hot pigment emerging from the oxidation reactor 14 has been moderated to some extent. Hotter gaseous and product stream moving down the first straight of the tubular conduit 34 would promote particle growth. With the increase in pressure drop of the tubular conduit 34 comes increased pressure at the oxidation reactor 14, a situation that tends to favor larger pigment particle size formation. This can be overcome by changing the tubular conduit 34 to the original configuration on the first straight, with, for example, a longer 225 mm conduit.

The new helical arrangement wherein the five degree and three degree helical portions 80A and 80B were placed in tandem led to advantages in finishing, including indications of improved washing, reduction in steam and natural gas usages, and increase in processing (plant capacity). One benefit was an increase in processing rate (blue tones run; a superdurable chloride rutile pigment, at 93% TiO₂ content, and with 325 mesh fineness of 0.01% maximum retention) through a spray drier. The new five degree helical pipe arrangement allowed an increase in average hourly rate on micronizers of 0.64 to 0.73 tph. Denser pigment slurry feed, due to improved washing and dewatering as the result of reduction in salt content, was at least partly responsible for improvement in throughput at the spray driers.

Non-destructive testing (NDT) was carried out on the new five degree helical portion after three weeks of operation. There was no indication of wear to the new five degree helical portion. Theoretically, a possibility of increase wear exists for the first and second sweeping bends 56. This is because they are likely to encounter higher velocity and higher flow stream temperatures which can lead to higher rate of erosion and corrosion. However, the increase in wear may not be significant as it will be mitigated by reduction in salt usage.

The heat removal efficiency of the helical portion of Example 1 (helix angle of three degrees) relative to a straight pipe is 21.6%. The considerable reduction in scrub salt indicated the new five degree helical portion heat efficiency is most probably more than 100%. Recent trial data confirmed that the new five degree helical portion removed 513 kW of heat under similar trial conditions for the three degree helical portion of Example 1. This equates to a heat removal efficiency of 204% of a straight conduit, an increase of more than five times when compared with the three degree helical portion of Example 1. Evidently, there is a large increase in heat removal efficiency from three to five degree helix angle. Thus, it is preferred that the tubular conduit 34 should include at least four to five degree helical portions 48. If installed in the third or fourth straight of the tubular conduit 34, a larger helix angle to deflect the flow is desirable, as wear is not anticipated to be a problem at these locations. However, there is a limit as the helix angle increases the off center distance (crest) of the helical portion 48. In practicality, the helix angle will be limited by the depth of the flue pond 36 containing the tubular conduit 34; the helix angle should preferably not be so high as to result in a crest in the tubular conduit 34 rising above the surface of the flue pond 36.

The performance of the new five degree helical portion opens up a new scope in the tubular conduit 34 configuration. As mentioned earlier, the third and fourth straight can be converted to helical portion to further increase the heat transfer efficiency of the flue pond 36. This change would make the current third loop 74 (fifth and sixth straights 76A and 76B) of the tubular conduit 34 redundant. In fact, a second straight 68B having a helical portion 48 with at least a five degree helix angle would be desirable.

Converting the second 68B or third 72A or fourth straight 72B of the tubular conduit 34 into helical portions 34 to increase their heat transfer efficiency is likely to cause the problem of maintaining acceptable pigment particle size. The reduction in scrub salt or scrubbing renders the first straight 68A less efficient in heat transfer especially its function of quenching the reaction products. There is a possibility that the tubular conduit 34 pressure drop may become excessive due to the larger volume of the hotter gases. As such, installing the helical portions 48 into the first straight 38A may be desirable under certain circumstances.

For neutral tone grade runs using the five degree helical portion in tandem with the three degree helical portion, the higher differential pressure and hotter first straight may have greater impact on the pigment particle size for the blue tone run. It may be slightly more difficult to produce smaller pigment particle size because the new five degree helical portion in the location tested decreases the quenching effect of the first straight 68A.

While the invention has been described in connection with specific embodiments thereof, it will be understood that it is capable of further modifications and this application is intended to cover any variations, uses, or adaptations of the invention following, in general, the principles of the invention and including such departure from the present disclosure as come within known or customary practice within the art to which the invention pertains and as may be applied to the essential features hereinbefore set forth and as follows in the scope of the appended claims.

What is claimed is:

1. A system for manufacturing a pigment, the system comprising:
an oxidation reactor for of providing a pigment;
a scouring media source capable of providing a scouring media;
a heat exchanger in fluid communication with the oxidation reactor and the scouring media source so as to receive a mixture of the pigment and the scouring media, the heat exchanger comprising:
a tubular conduit through which the mixture of the pigment and the scouring media flows, the tubular conduit having an inlet, an outlet, and a longitudinal center line, the tubular conduit being configured such that at least a portion of the longitudinal center line of the tubular conduit extends in a helical pattern; and
means for cooling at least a portion of the tubular conduit; and
a filter positioned to receive the mixture of the pigment and the scouring media from the outlet of the tubular conduit, the filter capable of separating the pigment from the scouring media.

2. The system of claim 1, further comprising a storage member for receiving and retaining the separated pigment from the filter.

3. The system of claim 1, wherein at least two portions of the longitudinal center line of the tubular conduit extend in a helical pattern.

4. The system of claim 1, wherein the entire longitudinal center line of the tubular conduit extends in a helical pattern.

5. The system of claim 1, wherein the tubular conduit comprises a lumen, and wherein said lumen contains titanium dioxide.

6. The system of claim 1, wherein means for cooling includes a jacket configured to surround at least a portion of the tubular conduit, the jacket spaced apart from the tubular member to define an annulus through which a cooling fluid flows around at least a portion of the tubular conduit.

7. The system of claim 1, wherein means for cooling includes a flue pool for retaining a cooling fluid, wherein at least a portion of the tubular conduit contacts the cooling fluid of the flue pool.

8. The system of claim 1, wherein the pigment is a titanium-based pigment.

9. The heat exchanger of claim 1, wherein the scouring media is selected from the group consisting of: titanium dioxide, sintered titanium dioxide, compressed titanium dioxide, salts and salt mixtures, sand, rock salts, alumina, fused alumina, and combinations thereof.

10. The system of claim 1, wherein the scouring media is a salt selected from the group consisting of: potassium chloride, sodium chloride, cesium chloride, and combinations thereof.

11. The system of claim 1, wherein the helical pattern formed by at least a portion of the tubular conduit includes a helix angle of approximately 1 to 20 degrees.
